(19) United States
(12) Patent Application Publication
(10) Pub. No.: US 2015/0206452 A1
(43) Pub. Date: Jul. 23, 2015

(54) METHOD AND SYSTEM FOR PERSONALIZED FINANCIAL EDUCATION

(71) Applicant: Financial Finesse, Inc., El Segundo, CA (US)

(72) Inventor: Liz Davidson, El Segundo, CA (US)

(73) Assignee: Financial Finesse, Inc., El Segundo, CA (US)

(21) Appl. No.: 14/656,594

(22) Filed: Mar. 12, 2015

Related U.S. Application Data
(63) Continuation-in-part of application No. 13/091,959, filed on Apr. 21, 2011, now abandoned.
Application No. 13/091,959 is a continuation-in-part of application No. PCT/US09/61551, filed on Oct. 21, 2009.
(60) Provisional application No. 61/107,222, filed on Oct. 21, 2008.

(51) Int. Cl. G09B 19/18

(52) U.S. Cl. CPC G09B 19/18

(57) ABSTRACT

The present invention includes methods and systems for providing a personalized financial education curriculum to an individual or an organization with employees. In some embodiments, the invention also includes systems and methods for generating financial wellness reports regarding the relative financial wellness of an individual or an organization as a whole, based upon one or more financial wellness assessments.

### CROSS REFERENCE TO RELATED APPLICATIONS

This application is a continuation-in-part of currently pending U.S. patent application Ser. No. 13/091,959, which was filed Apr. 21, 2011, and which is a continuation-in-part of International Application No. PCT/US09/61551, filed Oct. 21, 2009, which claims the benefit of U.S. Provisional Patent Application No. 61/107,222, filed Oct. 21, 2008.

### FIELD OF THE INVENTION

The field of the present invention relates to a method and system for providing and/or recommending personalized financial education materials and/or recommending financial education events to an end user.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

The computer and internet have become critical tools for educating and providing information to the general public on virtually all topics. As finance and investment information has traditionally been reserved for individuals able to afford the knowledge, many have turned to the internet as a frugal alternative for educating themselves regarding finance and investing. However, given the unlimited number of variables associated with each individual's financial state throughout various stages in life, the ability to provide financial enlightenment tailored for each individual has been very difficult to provide and often labor intensive to achieve.

One of the greatest attributes of the computer is the ability to process and analyze information in a fraction of the time required for these calculations to be performed manually. Of course, in order to allow a computer to perform useful functions, and optimize such functions, software designed with efficient and specific functionality is particularly critical. Such software is often referred to as a “tool.” The architecture or framework behind the tool is often described as a “platform.” The platform allows application of the tool, and typically incorporates the computer's architecture, operating system, programming languages and related runtime libraries or graphical user interface.

The current methods for financial education may incorporate a platform which uses an online search engine, database, corporate manuals, event lists, or other data sources to provide information about useful educational resources (including but not limited to educational materials and events, such as live or recorded seminars and webinars) which may be relevant to the end user's topic of interest. For example, an end user may input his topic of interest and the search engine may examine its index and provide a listing of best-matching web pages according to the search engine's criteria. Alternatively corporate policies and manuals may be reviewed to produce information corresponding to the end user's inputted query.

In mining for information, most search engines implement the use of Boolean operators (e.g. and, or, not) or proximity searches to specify the search query. However, these restrictions are not always fruitful as search engines regularly identify the relevance of a webpage based on third-party ratings or employ methods to rank the results to provide the “best” results first. Furthermore, the methodologies used by search engines in determining what information best matches an end user's topic of interest, and what order the information should be presented, is influenced by conflicting variables, such as sponsored links and popularity. The unrestricted flow of information and the ability for end users to download information, as well as misinformation, has led to an unreliable and unrestricted pool of data. As internet search engines have morphed to better siphon the data and produce focused rather than relevant information to end users, the level of sophistication and organization required to distinguish and identify the pertinence of the information, as well as misinformation, has yet to be implemented with efficiency.

Accordingly, traditional methods and systems for producing educational material on a specific topic of interest are rarely responsive and oftentimes occupy the end user's time with frivolous advertising and superfluous information rather than specific information. These frustrations commonly result in an extended investment of time and effort on the part of end users to educate themselves regarding a specific topic of interest.

Due to the disadvantages associated with the traditional methods and systems for providing relevant educational information to an end user, there exists a need for an education method and system that is capable of delivering specific information to an end user. There is a further need for a method and system to distinguish and catalog educational materials and events by subject, category, and sub-category, and identify and address the specific topic of interest of the end user efficiently, thus providing the end user with educational material that is parallel with the topic of interest.

Finally, there is also a need for a computer system and method designed to recommend a personalized financial education curriculum to an individual, after providing an initial or repeated assessment of the individual's competency and/or comfort level with regard to one or more topics related to financial planning.

### SUMMARY OF THE INVENTION

In various embodiments, the invention teaches a method for recommending a personalized financial education curriculum to an individual. In some embodiments, the method includes utilizing a computer to perform steps that include: (1) providing a questionnaire to the individual, wherein the questionnaire includes one or more questions relating to the individual's comfort level and/or competence and/or preparedness with regard to one or more financial planning topics; (2) assigning a score to the individual's response to one or more of the questions and/or assigning a score to one or more topics to which one or more of the questions relate, wherein a score for a response to a question is assigned based upon the strength of the response to the question, relative to an ideal response; and a score for a topic is assigned based upon the strength of a response or responses to one or more questions relating to the topic, relative to an ideal response or responses; (3) generating an electronic financial wellness report for the individual, wherein the electronic financial wellness report includes scores for two or more of the responses and/or topics; and (4) generating a list of one or more financial education resources for the individual, wherein said one or more financial education resources are intended to improve a person's comfort level and/or competence with regard to one or more of the topics for which a score lower than a predetermined threshold value was assigned, and wherein at least one listed financial education resource is a financial education event; thereby recommending a personalized financial education curriculum to the individual. In certain embodiments, one or more of the financial education events are accessible via the internet. In some embodiments, the individual is an employee of an organization, and one or more of the financial education events are held at the employee's place of employment. In certain embodiments, the individual is an employee of an organization, and one or more of the financial education events are not held at the employee's place of employment. In some embodiments, the method further includes providing the individual with access to register for one or more of the financial education events. In some embodiments, the access is provided by providing a hyperlink to a webpage where registration for the event can be accomplished. In some embodiments, the method includes providing the individual with an option to be included in an interest list for one or more of the financial education events. In certain embodiments, the method further includes repeating steps 1 and 2 listed above and subsequently generating an updated financial wellness report for the individual, wherein the updated financial wellness report includes scores of the individual's responses to each of the questionnaires. In certain embodiments, the method further includes generating an updated list of one or more financial education resources for the individual, wherein the contents of the updated list are determined in part by the improvement or lack of improvement of a score assigned to a topic on the updated financial wellness report, compared to a previously generated financial wellness report. In some embodiments, the method further includes providing the individual's employer with an electronic copy of the individual's financial wellness report and/or a list of one or more financial education resources recommended for the individual, based upon the list generated in step 4 described above.

In various embodiments, the invention teaches a non-transitory computer-readable medium having instructions stored thereon that when executed by a processor of a computer cause the computer to perform steps including: (1) providing a questionnaire to the individual, wherein the questionnaire includes one or more questions relating to the individual's comfort level and/or competence and/or preparedness with regard to one or more financial planning topics; (2) assigning a score to the individual's response to one or more of the questions and/or assigning a score to one or more topics to which one or more of the questions relate, wherein a score for a response to a question is assigned based upon the strength of the response to the question, relative to an ideal response; and a score for a topic is assigned based upon the strength of a response or responses to one or more questions relating to the topic, relative to an ideal response or responses; (3) generating an electronic financial wellness report for the individual, wherein the electronic financial wellness report includes scores for two or more of the responses and/or topics; and (4) generating a list of one or more financial education resources for the individual, wherein said one or more financial education resources are intended to improve a person's comfort level and/or competence with regard to one or more of the topics for which a score lower than a predetermined threshold value was assigned, and wherein at least one listed financial education resource is a financial education event; thereby recommending a personalized financial education curriculum to the individual. In some embodiments, one or more of the financial education events are accessible via the internet. In certain embodiments, the individual is an employee of an organization, and one or more of the financial education events are held at the employee's place of employment. In some embodiments, the individual is an employee of an organization, and one or more of the financial education events are not held at the employee's place of employment. In certain embodiments, the steps further include providing the individual with access to register for one or more of the financial education events. In some embodiments, access to register for one or more of the financial education events is provided through a hyperlink to a webpage where registration for the event can be accomplished. In some embodiments, the steps further include providing the individual with an option to be included in an interest list for one or more of the financial education events.

In various embodiments, the invention teaches a method, including: providing an initial multiple choice questionnaire to two or more employees of an organization, wherein the initial multiple choice questionnaire includes two or more questions and two or more possible answers for each question, and wherein each question is designed to assess an individual's competence and/or comfort level with regard to an aspect of financial planning; optionally assigning a score to each employee's selected answer to each of the two or more questions included in the initial multiple choice questionnaire, wherein the score is assigned based upon the strength of the selected answer to the question, relative to an ideal answer; providing a subsequent multiple choice questionnaire to the two or more employees of the organization, wherein the subsequent multiple choice questionnaire includes two or more questions and two or more possible answers for each question, and wherein (1) each question is designed to assess an individual's competence and/or comfort level with regard to an aspect of financial planning, and (2) each of at least two questions of the subsequent multiple choice questionnaire are the same or substantially the same as a question of the initial multiple choice questionnaire; optionally assigning a score to each employee's selected answer to each of the two or more questions included in the subsequent multiple choice questionnaire, wherein a score is assigned based upon the strength of the selected answer to the question, relative to an ideal response; and generating a report including a comparison of the employees' selected answers in response to the initial questionnaire and the subsequent questionnaire. In certain embodiments the comparison of the employees' selected answers includes a comparison or listing of the number or percentage of employees who selected each of the possible answers in the initial and subsequent questionnaires. In certain embodiments, each step of the method is executed by a computer or computer system (including but not limited to any of the computers or computer systems described herein). In certain embodiments, the method further includes providing the report to the employer of the employees who responded to the questionnaire.

In various embodiments, the invention teaches a non-transitory computer-readable medium having instructions stored thereon that when executed by a processor of a computer cause the computer to perform steps including: providing an initial multiple choice questionnaire to two or more employees of an organization, wherein the initial multiple choice questionnaire includes two or more questions and two or more possible answers for each question, and wherein each question is designed to assess an individual's competence and/or comfort level with regard to an aspect of financial planning; optionally assigning a score to each employee's selected answer to each of the two or more questions included in the initial multiple choice questionnaire, wherein the score is assigned based upon the strength of the selected answer to the question, relative to an ideal answer; providing a subsequent multiple choice questionnaire to the two or more employees of the organization, wherein the subsequent multiple choice questionnaire includes two or more questions and two or more possible answers for each question, and wherein (1) each question is designed to assess an individual's competence and/or comfort level with regard to an aspect of financial planning, and (2) each of at least two questions of the subsequent multiple choice questionnaire are the same or substantially the same as a question of the initial multiple choice questionnaire; optionally assigning a score to each employee's selected answer to each of the two or more questions included in the subsequent multiple choice questionnaire, wherein a score is assigned based upon the strength of the selected answer to the question, relative to an ideal response; and generating a report that includes a comparison of the employees' selected answers in response to the initial questionnaire and the subsequent questionnaire. In some embodiments, the steps further include providing the generated report to the employer of the employees.

In additional embodiments, the invention relates to methods and systems for providing personalized educational material responsive to an end user's chosen topic of interest. The methods and systems capture and digest various inputs provided by the end user, and determine specific finance, investing and finance management topics of interest relevant to the end user. The topics of interest are determined using at least one computer based topic algorithm which analyzes the end user's inputs. Relevant educational materials are captured and analyzed from a database and cataloged using a computer based catalog algorithm. A correspondence algorithm correlates the cataloged educational materials with the end user's topic of interest, producing personalized educational materials coinciding with the end user's topic of interest. The educational materials are related to the field of finance, investing and finance management.

The invention also relates to methods and systems for providing an end user with an assessment of their financial wellness based on the user's response to a plurality of questions. The assessment may include one or more scores, comparisons to other users, vulnerabilities, and plans for action. Additionally, the assessment may provide educational materials to the user based on responses to financial wellness related questions.

The invention also relates to methods and systems for aggregating and analyzing responses from a plurality of associated users (e.g., employees of a company or other organization). The results of the analyzed responses may be provided to an organization in a variety of useful formats. By capturing user-provided financial wellness information and analyzing it, companies or other organizations may determine how to best design effective and impactful financial education programs for their employees.

An embodiment of the present invention provides a method for providing educational material in response to an end user's input, the method comprising accessing a database for educational materials, analyzing and cataloging the educational materials found in the database, querying the end user to identify a topic of interest based on the end user's response to the query, identifying educational material from the database corresponding with the identified topic of interest, and presenting educational material to the end user through a graphic user interface (GUI).

In an embodiment of the invention, the database may be in communication with a network. In addition the database may comprise a catalog, a corporate manual, an electronic data source, or combinations thereof.

In an embodiment of the invention, the step of querying the end user may comprise soliciting a response to a question, prompting a selection from at least two choices, prompting a response to a yes/no question, soliciting an input, or combinations thereof.

In an embodiment of the invention, the step of identifying at least one topic of interest based on the results of the query comprises the use of a topic algorithm.

In an embodiment of the invention, the step of analyzing educational material from the database relevant to various topics of interests may comprise the use of an analysis algorithm.

In an embodiment of the invention, the step of cataloging educational material from the database corresponding with at least one topic of interest may comprise the use of a catalog algorithm.

In an embodiment of the invention the topic of interest is finance, investing, financial planning, finance management, or combinations thereof.

In an embodiment of the invention, the database may be supplemented with additional educational material.

In an embodiment of the invention, the step of identifying educational material corresponding with the at least one topic of interest may comprise the use of a correspondence algorithm.

In an embodiment of the invention, the method may further comprise calculating a financial wellness score based on the results of the query by weighing the results against optimal wellness criteria in a plurality of areas of personal finance.

An embodiment of the present invention provides a computer-usable medium having readable instructions stored thereon that when executed by a processor perform a method for providing educational material in response to an end user's input, the method comprising accessing a database of educational materials, analyzing and cataloging the educational materials found in the database, querying the end user to identify a topic of interest based on the end user's response to the query, identifying educational material from the database corresponding with the identified topic of interest, and presenting the corresponding educational material to the end user through a graphic user interface (GUI).

In an embodiment of the invention, the database may be in communication with a network. In addition the database may comprise a catalog, a corporate manual, an electronic data source, or combinations thereof.

In an embodiment of the invention, the step of querying the end user may comprise soliciting a response to a question, prompting a selection from at least two choices, prompting a response to a yes/no question, soliciting an input, or combinations thereof.

In an embodiment of the invention, the step of identifying at least one topic of interest based on the results of the query comprises the use of a topic algorithm.

In an embodiment of the invention, the step of analyzing educational material from the database relevant to various topics of interests may comprise the use of an analysis algorithm.

In an embodiment of the invention, the step of cataloging educational material from the database corresponding with at least one topic of interest may comprise the use of a catalog algorithm.

In an embodiment of the invention, the topic of interest is finance, investing, financial planning, finance management, or combinations thereof.

In an embodiment of the invention, the database may be supplemented with additional educational material.

In an embodiment of the invention the step of identifying educational material corresponding with the at least one topic of interest may comprise the use of a correspondence algorithm.

An embodiment of the invention provides a method for providing a financial wellness assessment to a user, comprising: presenting a plurality of questions to the user through a graphical user interface (GUI), the questions relating to one or more financial topics; receiving responses to the plurality of questions from the user; analyzing the responses received from the user according to a predetermined algorithm; comparing the responses received from the user to a larger sample of responses; determining an overall financial wellness score of the user based on the user's responses to the plurality of questions and predetermined financial wellness criteria; presenting the overall financial wellness score to the user through the GUI; and presenting to the user a comparison of a financial characteristic between the user and the larger sample.

In an embodiment of invention, the method of calculating the unique financial wellness score based on the input received from the user includes calculating the wellness score components for each of the major personal finance areas of concern (also described as “topics” herein), such as debt management, cash flow, retirement, investing, etc., as well as overall score for the user; using such score as the objective metrics of the user's financial well-being; and using such score for comparing the user's financial wellness to other users in the group and/or nationwide.

In an embodiment of the invention, the method includes identifying at least one topic of interest based on the responses received from the user; identifying available educational material and/or educational events corresponding with the at least one topic of interest; and presenting or offering access to the corresponding educational material and/or a list of relevant educational events to the user through the GUI. In some embodiments, the educational material and educational events relate to education about financial planning matters.

In an embodiment of the invention, the method includes identifying at least one vulnerability of the user based on the responses received from the user; and presenting and/or offering related educational material and/or generating a list of relevant educational events aimed at educating attendees about the identified vulnerability. In some embodiments of the invention, the educational material and/or list of relevant educational events are presented to the user through the GUI.

In an embodiment of the invention, at least one of the plurality of questions relates to the user's priorities regarding financial topics, and the method further comprising presenting a comparison between the user and the larger sample relating to a financial topic that the user has indicated to be a priority.

An embodiment of the invention provides a method for providing a financial wellness assessment report (also described herein as a “financial wellness report”) for an association or organization, comprising: receiving a plurality of responses from associated or organized users (for example a plurality of individual employees of an organization) to a financial wellness assessment questionnaire; analyzing the responses in aggregate according to an algorithm to determine one or more financial wellness characteristics of the association; comparing the responses to a larger sample of responses; and providing results of the analysis to the association.

In an embodiment of the invention, the method includes an algorithm for calculating the financial wellness score for the association or organization as an overall score and separate component scores for each of the personal finance areas of concern; and using said scores as objective metrics and key performance indicators to compare the association or organization with the peers and/or nationwide averages as well as comparing various demographics slices within the association or organization.

In an embodiment of the invention, the method includes providing a recommended financial education plan to the association or organization based on the analyzed responses and the calculated financial wellness scores.

In an embodiment of the invention, providing results comprises providing results based on demographic information for the members of the association or organization (e.g. employees). In some embodiments, the demographic information includes one or more of age, income, gender, and geographic location.

An embodiment of the present invention provides a computer-usable medium having readable instructions stored thereon that when executed, cause a processor to perform a method for providing a financial wellness assessment report for an association or organization, the method comprising: receiving responses to a financial wellness assessment questionnaire for a plurality of associated or organized users; analyzing the responses in aggregate according to an algorithm to determine one or more financial wellness characteristics of the association or organization; comparing the responses to a larger sample of responses; and providing results of the analysis to the association or organization.

An embodiment of the present invention provides a system for providing a financial wellness assessment report for an association or organization, comprising: a computer comprising a processor operative to execute instructions to perform a method for providing a financial wellness assessment report for an association or organization, the method comprising: receiving responses from members of the organization or association to a financial wellness assessment questionnaire; analyzing the responses in aggregate according to an algorithm to determine one or more financial wellness characteristics of the association or organization; comparing the responses to a larger sample of responses received from other associations or organizations; and providing results of the analysis to the association or organization.

Other features and advantages of the invention will become apparent from the following detailed description, taken in conjunction with the accompanying drawings, which illustrate, by way of example, various features of embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 is a diagram depicting a summary of information to detailed data process, in accordance with an embodiment of the invention.

FIG. 2 is a diagram depicting a summary of information to detailed data process, in accordance with an embodiment of the invention.

FIG. 3 is a flow chart depicting a personalized educational material selection process, in accordance with an embodiment of the invention.

FIG. 4 is a block diagram depicting exemplary components of a platform, in accordance with an embodiment of the invention.

FIG. 5 is a block diagram depicting exemplary components of a platform, in accordance with an embodiment of the invention.

FIG. 6 is a diagram of a process for generating and presenting a financial wellness assessment for a user in accordance with an embodiment of the invention.

FIG. 7 is a diagram illustrating a graphical user interface for presenting a financial wellness assessment to a user, in accordance with an embodiment of the invention.

FIG. 8 is a diagram of a process for generating and presenting a financial wellness assessment report for an organization, in accordance with an embodiment of the invention.

FIG. 9 is a diagram illustrating a graphical user interface for presenting a financial wellness assessment report for an organization, in accordance with an embodiment of the invention.

FIG. 10 is a diagram illustrating a graphical user interface of a score comparison for a financial wellness assessment report, in accordance with an embodiment of the invention.

FIG. 11 is a block diagram of a suggested financial education plan for an organization, in accordance with an embodiment of the invention.

FIGS. 12A, 12B and 12C each depict a section of a report generated for an organization, which demonstrates the progress in the financial wellness of its employees between a first and final assessment, in accordance with an embodiment of the invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which the invention belongs. One skilled in the art will recognize many methods and systems similar or equivalent to those described herein, which could be used in the practice of the invention.

One skilled in the art will recognize many methods and systems similar or equivalent to those described herein, which could be used in the practice of the present invention. Indeed, the present invention is in no way limited to the methods and systems described. For purposes of the present invention, the following terms are defined below.

“Algorithm” as used herein refers to an effective method for solving a problem using a finite sequence of instructions. Algorithms are used for calculation, data processing, and many other fields. Each algorithm is a list of well-defined instructions for completing a task. Starting from an initial state, the instructions describe a computation that proceeds through a well-defined series of successive states, eventually terminating in a final ending state.

“Network” as used herein refers to a global system of interconnected computer systems that use a standardized language for communication (e.g. Internet Protocol Suite-TCP/IP).

“Platform” as used herein describes a hardware architecture or software framework (including application frameworks) that allows software to run. Typical platforms include a computer's architecture, operating system, programming languages and related runtime libraries or graphical user interfaces.

“Software” as used herein describes the role that computer programs, procedures and documentation play in a computer system. Software encompasses an extremely wide array of products and technologies developed using different techniques like programming languages, scripting languages, microcode, or an FPGA configuration.

“Event” as used herein in the context of an event or list of events identified or generated by the computer system or platform, include events occurring at an end user's place of employment, as well as events occurring elsewhere, which are accessible either by computer or other electronic interface, or by traveling outside of the end user's place of employment. As used herein, “topic of interest” means any topic identified as important to a person, groups of persons, an organization, or an association, for educational purposes or otherwise, whether identified by a person or by a computer (for example after one or more assessments described herein).

In various embodiments, the invention teaches methods and systems for providing and/or identifying personalized educational material and/or events responsive to an end user's query and/or responses to a series of questions designed to identify a topic of interest. In some embodiments, the invention may use a computer-usable medium having readable instructions stored thereon that when executed by a processor found in the platform interact with an end user to recommend and/or provide educational material(s), and/or recommend upcoming events relevant to a topic of interest. In various embodiments, the invention provides a platform for interacting with the end user in order to determine characteristics and criteria specific to the end user and to establish one or more topics of interest. In certain embodiments, the identified characteristics and criteria are used to cross-reference a database of educational materials and events, in order to determine those educational materials and events specific to the end user's query, and to present and/or recommend educational materials and/or recommend events to the end user for the purpose of edification.

In some embodiments, the educational materials and/or events recommended to the end user correspond with the topic of interest identified by the end user or computer program (for example through an assessment described herein) as pertinent, and aim to educate the end user in one or more topic of interest. In some embodiments, the method for identification of specific topics of interest is based on a platform which incorporates a computer's architecture, operating system, programming languages and related runtime libraries or graphical user interface (“GUI”). The platform can provide the backbone upon which determination of the end user's requested topic of interest is identified, as well as the means to determine and provide educational information and/or recommend events which correlate to the identified topic of interest. In some embodiments, the platform is further capable of gathering relevant educational information and information about upcoming events from outside content/resources, internal and external databases, as well as other resources. Merely by way of example, the platform may interact with a database which includes information about upcoming seminars relating to financial planning or another relevant topic. The platform may then recommend upcoming events to the end user which are related to a topic of interest identified by the end user, or by an assessment of the end user's competency in or comfort level with a particular subject (for example one or more topic related to financial planning), as identified by any method described herein. In certain embodiments, once gathered, the educational information and/or educational event information is analyzed and cataloged by at least one computer based algorithm, according to subject, category, sub-category, and further finite groupings if necessary. The cataloged educational materials and/or educational event information is then presented and/or recommended to the end user according to one or more topic of interest.

In some embodiments, the present invention provides a computer-usable medium having readable instructions stored thereon that when executed by a processor found in the platform present the end user with educational materials and/or a recommended list of events specific to a topic of interest for the end user, whether determined by the end user's query or automatically identified after the end user responds to a questionnaire described herein. In some embodiments, the computer-usable medium provides access to one or more database containing educational materials and/or a list of educational events, a means for searching the database, and a catalog algorithm for establishing a catalog of finance related educational materials and/or upcoming educational events. In some embodiments, the computer-usable medium captures information from the end user, and using a topic algorithm, determines a topic of interest based on the information received from the end user. In some embodiments, the information received from the end user can include a response to one or more questions regarding which areas of financial planning represent topics of interest to the end user. Alternatively, or in addition, the information received from the end user can be in the form of one or more responses to a financial wellness questionnaire designed to determine the end user′ competence and/or comfort level and/or desire to learn more about a particular topic relating to financial planning. In some embodiments, the platform is configured to incorporate the use of a computer-implemented correspondence algorithm to cross-reference the topic of interest determined from the aforementioned information provided by the end user, with educational information and/or a list of upcoming events cataloged, in order to recommend or present educational information and/or recommend additional resources (such as upcoming educational events) relevant to one or more topic of interest, as determined by any method described herein. In some embodiments, the information and/or recommendations are presented through a graphic user interface (whether on a desktop computer, laptop computer, handheld personal computing device or the like).

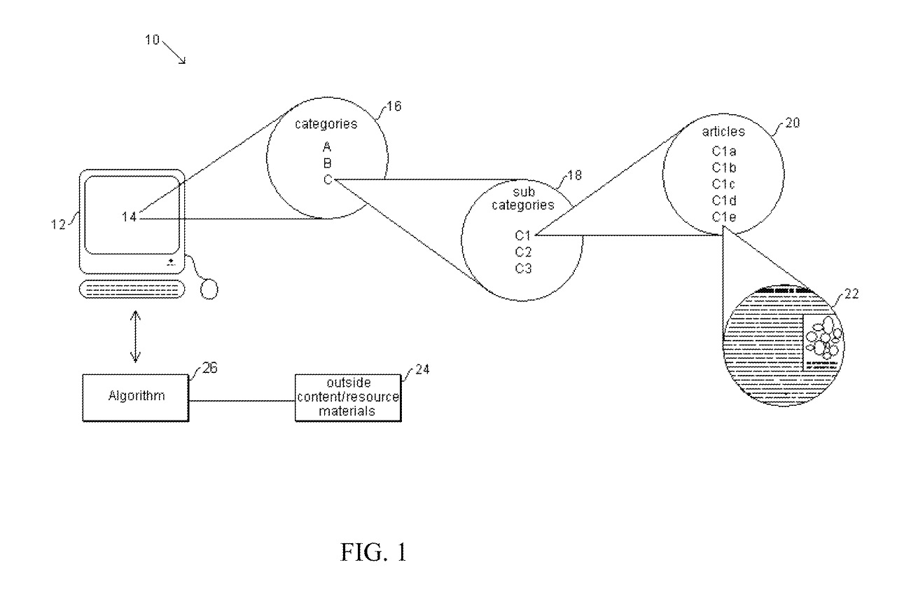

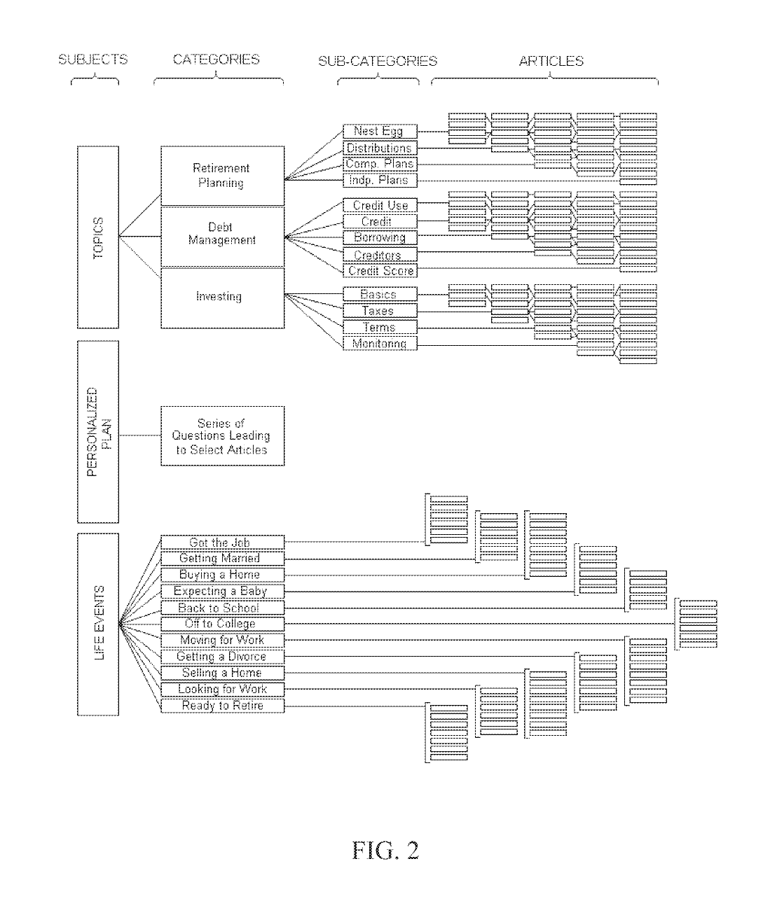

As an example, shown in FIG. 1, the end user interacts with the inventive financial education platform 10 through a GUI 12, or other appropriate medium know in the art. The GUI 12 provides at least one general financial subject 14 for selection by the end user. Once a general financial subject 14 is selected, at least one category 16 is available for selection by the end user to further narrow the type of financial information desired by the end user. Categories of financial information may include specific life events (such as buying a home or getting married), investing, retirement planning, or debt management, to name a few. Once a category 16 is chosen, at least one subcategory 18 is presented to the end user to further refine the financial information desired by the end user. Subcategories 18 are intended to provide more specific areas of interest within the chosen category 16 and allow the end user to further pinpoint the type of financial information sought. Merely by way of example, subcategories 18 may include topics such as: accumulating your nest egg; company sponsored retirement plans; making investment choices; and tax implications for investing. Once a subcategory 18 is selected, relevant articles and educational materials 20 are presented to the end user which may be opened in the GUI 12 and reviewed for edification 22.

The educational materials 20 presented for educating the end user may be gathered from outside content/resources 24 using the financial education platform 10 and at least one computer-based algorithm 26. Alternatively, the educational materials 20 may be uploaded directly onto the database, either to be cataloged or for cataloging by a catalog algorithm (not shown). The at least one algorithm 26 captures and analyzes the content/resource educational materials 20 and catalogs the content/resource materials 20 according to subject 14, category 16, subcategory 18, and other areas of interest according to keywords, if applicable. Individual content/resource materials 20 may be cataloged in multiple subjects 14, categories 16, subcategories 18, or combinations thereof. The materials 20 are then available for presentation to the end user based on the end user's selected preferences (e.g. categories and subcategories).

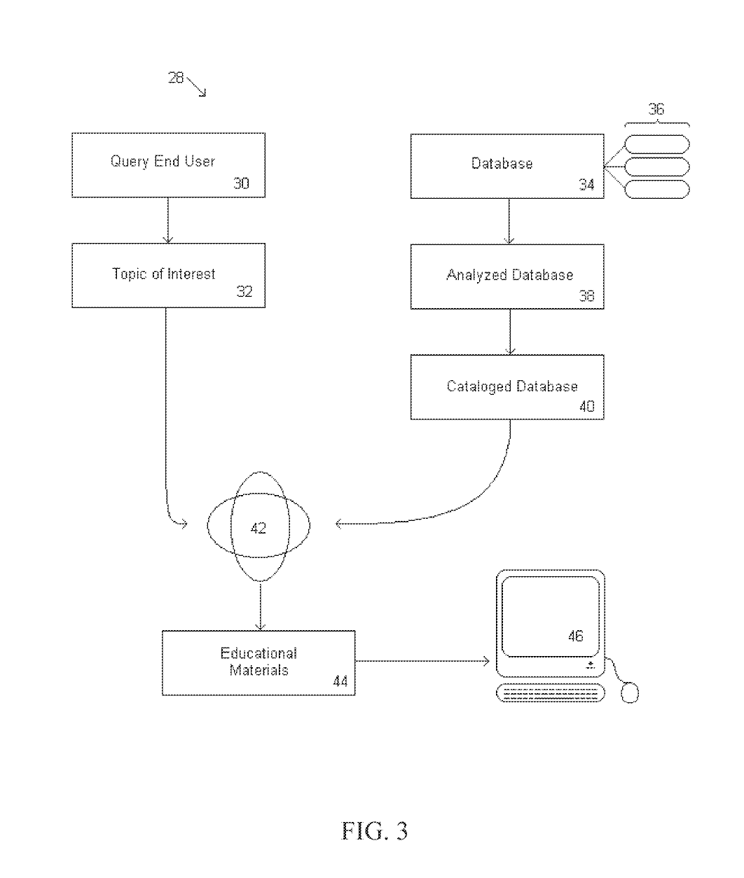

FIG. 3 depicts a flow chart of a personalized educational material selection process performed on a platform 28 in accordance with an embodiment of the invention. The flow chart shows a response to a query submitted by an end user 30, and the identification of a topic of interest 32 based on the query results. A topic algorithm operated on the platform may be used to compute responses to the query and determine the topic of interest 32. The flow chart further depicts a database 34, containing and having access to educational materials through at least one network 36. The database incorporates an analysis algorithm operated on the platform to analyze the educational materials in the database to produce an analyzed database 38. The analyzed database 38 is then cataloged based on subject, category, sub-category, articles, and further finite groupings if necessary, providing a cataloged database 40. The cataloged database 40 is established by incorporating a catalog algorithm operated on the platform 28. The cataloged database 40 is then cross-referenced with the topic of interest 32 determined for the end user, to identify specific educational material 44 for review by the end user. The specific educational material 44 is presented to the end user through a graphic user interface (GUI) 46, for the end user's edification.

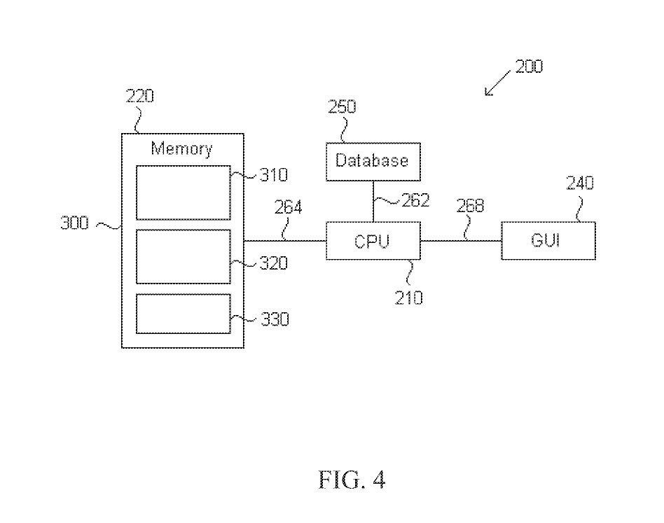

FIG. 4 is a block diagram of the components of the exemplary platform 200, in accordance with an embodiment of the invention. The platform 200 may include a programmable central processing unit (CPU) 210 which may be implemented by any known technology, such as a microprocessor, microcontroller, application-specific integrated circuit (ASIC), digital signal processor (DSP), or the like. The CPU 210 may be integrated into an electrical circuit, such as a conventional circuit board, that supplies power to the CPU 210. The CPU 210 may include internal memory and/or external memory 220 may be coupled thereto. The memory 220 may be coupled to the CPU 210 by a suitable internal bus 264.

The memory 220 may comprise random access memory (RAM), read-only memory (ROM), or other types of memory. The memory 220 contains instructions and data 310 that control the operation of the CPU 210. The memory 220 may also include a basic input/output system (BIOS) 320, which contains the basic routines that help transfer information between elements within the platform 200. The present invention is not limited by the specific hardware component(s) used to implement the CPU 210 or memory 220 components of the platform 200.

Optionally, the memory 220 may include external or removable memory devices 330 such as floppy disk drives and optical storage devices (e.g., CD-ROM, R/W CD-ROM, DVD, and the like). The platform 200 may also include one or more I/O interfaces (not shown) such as a serial interface (e.g., RS-232, RS-432, and the like), an IEEE-488 interface, a universal serial bus (USB) interface, a parallel interface, and the like, for the communication with removable memory devices such as flash memory drives, external floppy disk drives, and the like.

The platform 200 may also include a graphic user interface 240 such as a standard computer monitor, LCD, or other visual display. The user interface 240 may also include an audio system capable of playing an audible signal. The user interface 240 may permit the user to enter responses or commands into the platform 200. For example, the user may respond to a query in establishing a topic of interest computed by the platform 200. The user interface 240 may also comprise a means for accessing the database of educational material through a security protocol. The security protocol may prompt an end user to log-on to the platform by inputting a user name and password. The user interface 240 may include a standard keyboard, mouse, track ball, buttons, touch sensitive screen, wireless user input device and the like. The user interface 240 may be coupled to the CPU 210 by a suitable internal bus 268.

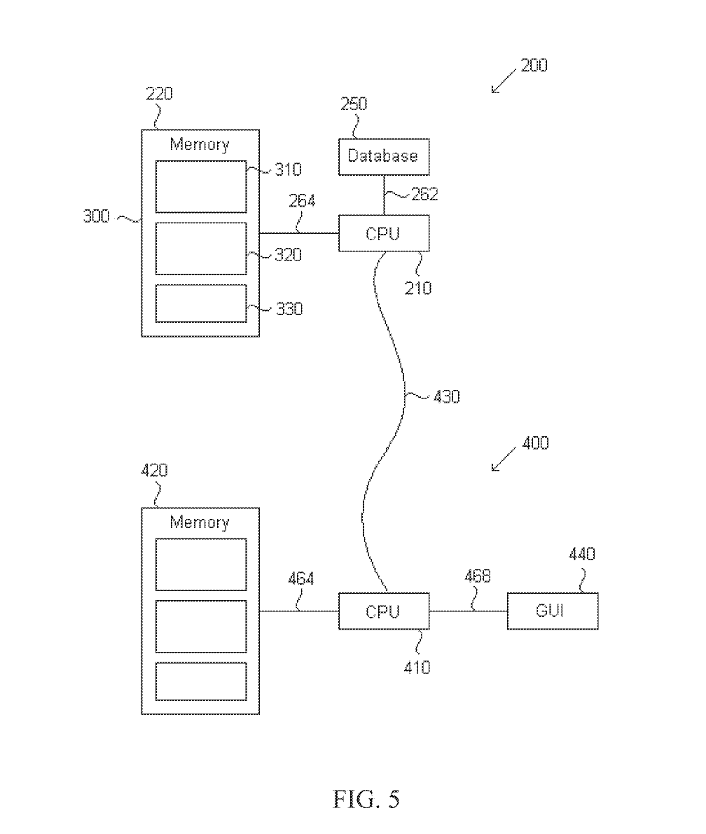

As shown in FIG. 5, the platform 200 may be in communication with at least one remote platform 400 for accessing the platform 200 through a network 430 (e.g., the Internet or other network). The remote platform 400 may be any suitable computer operative to access the platform 200. Such computers include desktop computers, laptop computers, mobile phones, tablet computers, and the like. The remote platform 400 may include a graphic user interface 440 such as a standard computer monitor, LCD, or other visual display. The user interface 440 may also include an audio system capable of playing an audible signal. The user interface 440 may permit the user to enter responses or commands into the platform 400 for interaction with the platform 200 through the network connection 430. For example, the user may respond to a query in establishing a topic of interest computed by the platform 200.

The user interface 440 may also comprise a means for accessing the database of educational materials through a security protocol. The security protocol may prompt an end user to log-on to the platform by inputting a user name and password. The user interface 440 may include a standard keyboard, mouse, track ball, buttons, touch sensitive screen, wireless user input device and the like. The user interface 440 may be coupled to the CPU 410 by an internal bus 468. The remote platform 400 may also include memory 420 coupled to the CPU 410 by an internal bus 464. The memory 420 may comprise random access memory (RAM) and read-only memory (ROM). The memory 420 may also include a basic input/output system (BIOS), which contains the basic routines that help transfer information between elements within the remote platform 400. The present invention is not limited by the specific hardware component(s) used to implement the CPU 410 or memory 420 components of the remote platform 400.

The platform 200 may also be in communication with an external database 250. The various components of the platform 200 may be coupled together by the internal buses 262, 264, and 268 (shown in FIG. 4). Each of the internal buses 262, 264, and 268 may be constructed using a data bus, control bus, power bus, I/O bus, and the like. The platform 200 may include instructions executable by the CPU 210 for operating the financial education methods and systems described herein. These instructions may include computer readable software components or modules stored in the memory 220, or stored and executed on one or more other computers of the platform.

In an alternative embodiment, the GUI may provide the option of creating a personalized financial educational plan by receiving specific information from the end user (such as one or more responses to questions of the questionnaires described herein), and relating the specific information to form a topic of interest. The personalized financial education plan may lead the end user through at least two questions to determine and identify educational materials in a specific subject, a category, a subcategory or other areas of interest to the end user by incorporating a topic algorithm. The resulting educational materials aim to educate the end user in that specific subject, category, subcategory, or area of interest.

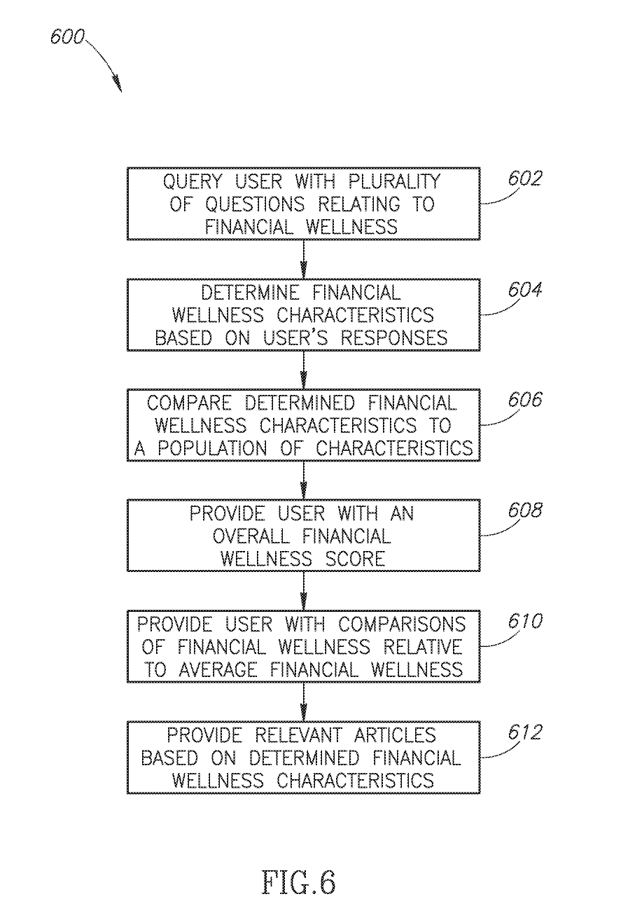

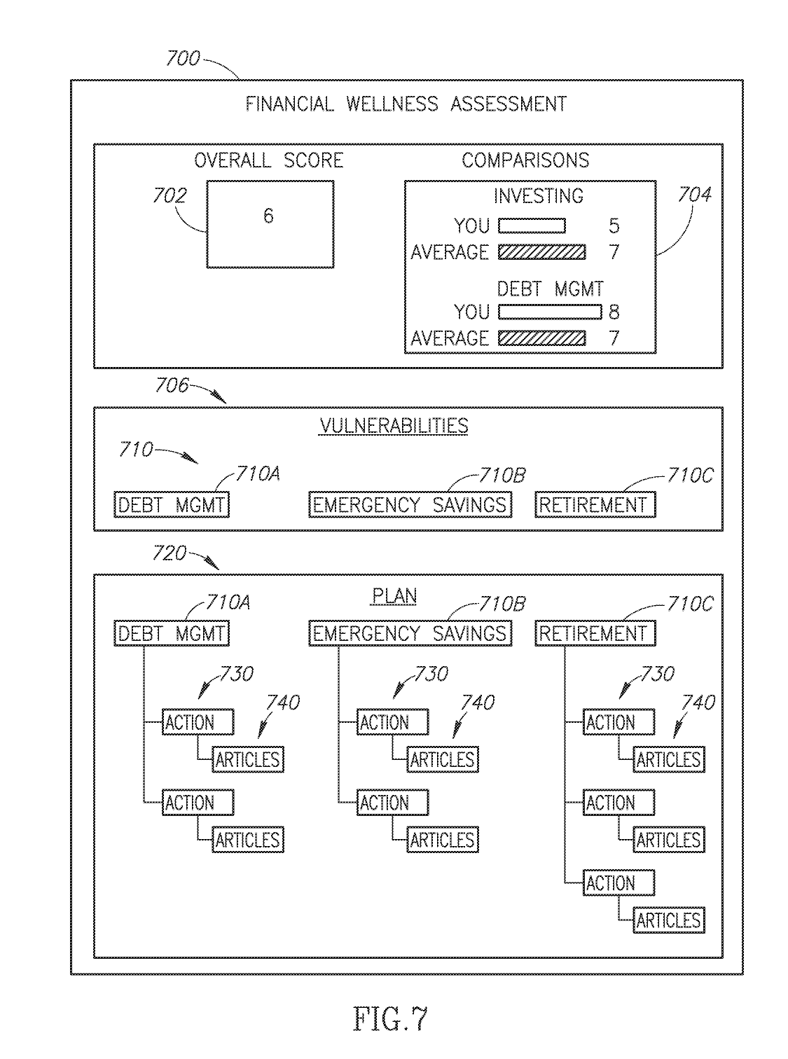

In an alternative embodiment, the personalized financial education plan prompts a series of questions to build a personalized learning plan and unique profile for each end user. In some embodiments a financial wellness assessment is provided to the end user in the form of questions in a questionnaire aimed at determining the knowledge and/or comfort level of the end user in with respect to one or more areas related to finance. The questions may include ranking topics according to importance, demographics (e.g. age, income, dependants), and/or background questions aimed to determine the individual's familiarity with specific topics, such as investing, 401(k), retirement planning, IRAs, income taxes, or other finance, investing, financial planning, finance management or related matters. The questions may also be of a personal nature, such as inquiries regarding the individual's money management skills, comfort level in various investing strategies, types of investing and/or credit card balances, or financial tendencies. Furthermore, the questions may inquire about the individual's future plans, goals, expectations, or risk adversities. The general goal of the questions is to devise a personalized, in-depth understanding of the individual's finances, his/her needs and goals, and his/her understanding and knowledge in and/or comfort level with one or more areas relating to finance, investing, financial planning, finance management or related matters. Responses to the aforementioned questions may be evaluated by a topic algorithm to automatically determine one or more topic of interest, and/or to generate a financial wellness assessment (see FIGS. 6 and 7). The one or more topic of interest is cross-referenced with the cataloged educational materials by a correspondence algorithm and specific educational material supplementing deficiencies in the end user's knowledge base, of interest to the end user, or responsive to other criteria considered pertinent are presented to the end user. In some embodiments, one or more topic of interest is cross-referenced with one or more upcoming financial education events (determined, cataloged and updated regularly), in order to identify one or more upcoming financial education events that are likely to be helpful in improving the end user's competency and/or comfort level with respect to one or more topic of interest. Advantageously, the financial education events can be from any source (i.e. provided by anyone that allows access to information about scheduled financial education events), and can be accessed by one or more of the information gathering mechanisms described herein. Thus, in a sense the educational event information generating aspect of certain embodiments of the invention is “open source.” In some embodiments, the platform is further configured to receive information regarding whether the end user attended one or more of the recommended events (via registration or attendance confirmed by the event organizer, end user, or otherwise), and that information can be used to determine the effectiveness of an educational event or combination of educational events in improving an end user's competency and/or comfort level with respect to one or more topics of interest, as assessed by administering one or more additional financial wellness questionnaires. In some embodiments, the platform is configured to recommend one or more additional financial education materials and/or financial educational events to the end user (or his or her employer) after one or more additional financial wellness questionnaires and assessments are completed and the results are analyzed and compared with those of a prior assessment. In this way, the effectiveness of one or more events (in terms of improved competence and/or comfort level) attended by the end user are considered when the recommendation is made. Considerations for the recommendations may thus include the teacher(s), subject matter, length of time, or other aspects of the attended events that may have contributed to their effectiveness or lack thereof. This analysis and associated recommendations and reporting may be performed for an individual end user, or an organization (or subpopulation thereof) or association (or subpopulation thereof), by utilizing the platforms, computer systems, methods and non-transitory computer-readable media described herein and configured therefor.

FIG. 6 illustrates an exemplary process 600 for generating a personalized financial wellness assessment (or simply “assessment”) for a user utilizing a platform, such as the platform 200 discussed above. The process begins at block 602, by querying a user with a plurality of questions aimed towards deciphering the knowledge of the user in one or more areas of finance. The questions may be provided to the user by a GUI, as described above. The questions may include demographics information (e.g., age, income, dependents, or the like), and/or background questions configured to determine the user's financial characteristics, interests, concerns, familiarity with certain financial topics, and the like. As described above, the questions may also be of a personal nature (e.g., comfort level with certain financial topics).

In block 604, the platform may determine one or more financial wellness characteristics of the user based on his/her responses to the questions. The responses provided by the user may be computed by one or more algorithms to determine the one or more financial wellness characteristics. In block 606, the user's responses and/or determined financial wellness characteristics may be compared to a population of users that have also answered the same questions. As can be appreciated, it may be desirable for the user to understand how their financial wellness and knowledge compares to other individuals. The comparison may be made with all other users that have previously completed the financial wellness assessment, or any number of subsets of users (e.g., similarly situated users).

In block 608, the user is provided with an overall financial wellness score (see FIG. 7). The overall financial wellness score may be calculated by taking the user's responses to the questions and weighing them against optimal wellness standards in key areas of personal finance, as assessed by certified financial planners. In the example shown in FIG. 7, the user's overall financial wellness score is measured based on a scale of 1 to 10 to give the user a clear idea of his/her level of overall financial wellness. In block 610, the system may also provide the user with a comparison of the user's financial wellness relative to the financial wellness or other financial characteristics of other users.

In block 612, the system may also provide the user (e.g., via a GUI) with key areas of vulnerabilities, along with resources (such as educational articles) to help the user improve those areas. The key areas of vulnerabilities identified may or may not include topics selected by the user as key priorities. In general, the results provided to the user are intended to provide feedback and an analysis of his/her personal financial situation as would be provided if the user were working with a financial planner. Using the method discussed above, the user is directed to personalized information concerning topics of interest without the expense of working with a financial planner.

FIG. 7 illustrates an exemplary display window 700 showing the results of a user's financial wellness assessment. Although shown as a single window, the content of the display window 700 may be provided to the user in any suitable manner. The window 700 includes an overall financial wellness score 702 that provides the user with a “snapshot” of their overall financial wellness. As discussed above, the overall financial wellness score 702 may be calculated by taking the user's responses to the questions and weighing them against optimal wellness in multiple areas of personal finance. In the example shown in FIG. 7, the user's overall financial wellness score 702 is a 6 out of 10, giving the user an idea of his/her level of overall financial wellness.

The display window 700 also includes a comparisons section 704 that includes one or more comparisons between the user and an average (e.g., a national average, an average among one or more demographics, or the like). In some embodiments, the comparisons section 704 of the results window 700 may provide the user with scores in the areas the user indicated were the most important topics to them. These scores reflect the user's overall wellness in these categories, in comparison to other users of the system. In the example shown in FIG. 7, the user may have selected investing and debt management as two of his or her most important topics. The comparisons section 704 then provides the user with an indication of how they rank in these topics compared with other users of the system.

The display window 700 may also include a vulnerabilities section 706 that includes a list of vulnerable categories 710 or areas of concern based on the results of the user's questions. In the example provided, the user's vulnerabilities may include debt management 710A, emergency savings objectives 7108, and saving for retirement 710C. In addition to listing the user's vulnerabilities (or areas of concern), the vulnerabilities section 706 may also provide a general statement regarding vulnerability. For example, for debt management 710A, the section 706 may include a message indicating to the user that his/her monthly debt payments are costing them money that could otherwise be used to save for future goals.

The display window 700 may also include a plan section 720 devised to provide the user with information and steps to address the identified vulnerabilities or areas of concern 710. As shown, for each of the vulnerabilities 710A, 7108, and 710C listed in the vulnerabilities section 706, there is one or more actions 730 and associated articles 740 (or other information including spreadsheets, data, or other educational resources). As an example, the debt management category 710A may include a first action 730 relating, for example, to reducing credit card payments. Under this action, one or more articles 740 relating to credit card debt and payments may be provided. The debt management category 710A may also include a second action 730 relating, for example, to the order in which debt payments should be paid. This second action 730 may include one or more associated articles 740 relating to this topic (e.g., a debt payment plan calculator, articles regarding debt payment schedules, and the like). As with the debt management category 710A, the plan section 720 of the financial wellness assessment may include actions 730 and associated articles 740 with the emergency savings category 710B and the retirement savings category 710C as well. In addition to addressing the categories identified in the vulnerabilities section 706, the plan section 720 may also include information on other categories (e.g., categories of interest, priorities, requested information, and the like).

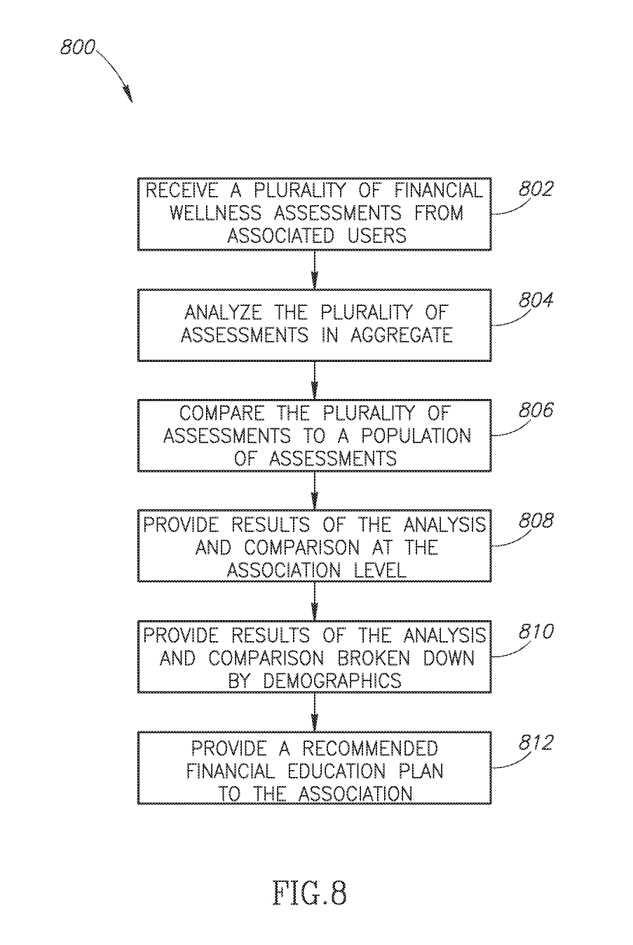

Other embodiments of the present invention are directed to methods and systems for aggregating and analyzing responses of a plurality of associated users (e.g., employees of a company or other organization) that have completed the aforementioned financial wellness assessment and education plan. Because the aggregated data is compiled from the responses provided by users to create their individual assessments and education plans, the content of their responses is not simply from a survey. That is, employees (or other associated users) answer the questions for a reason—to get the tools they need to find answers, information, and resources for their most pressing financial issues. Thus, the data is more reliable than simple survey data. In this regard, employers (or other associations or organizations) using this analyzed data are able to design an effective and impactful financial education program to address those issues. FIG. 8 illustrates a process 800 for generating and presenting a financial wellness assessment report for an organization, such as an employer or other organization. The process 800 may be executed on any suitable platform, such as the platform 200 described above. The process 800 begins at block 802 by receiving a plurality of financial wellness assessments from a plurality of users. For example, the system may receive the all the responses to the questions described above for all the employees of a company. As can be appreciated, the responses may first be “anonymized” so that each individual's responses are kept private.

In block 802, the anonymized responses and assessments (collectively “data”) are analyzed in aggregate according to one or more algorithms. The algorithms may be configured to analyze the responses to determine one or more characteristics of the users' responses. Such characteristics include financial priorities, indications of financial wellness, comfort levels with various financial topics, areas of concern, and the like. Additionally, in block 804, the data may be compared against a population of data to determine financial wellness characteristics of a company or organization relative to a larger group (e.g., a national average, an average of similar organizations, or the like).

To provide detailed and useful information for an association, the data may be analyzed both at the association level as well as broken down by demographics (e.g., age, income level, gender, geographic location, and the like). In this regard, associations may be able to tailor their financial education plans to address issues of particular groups within their association.

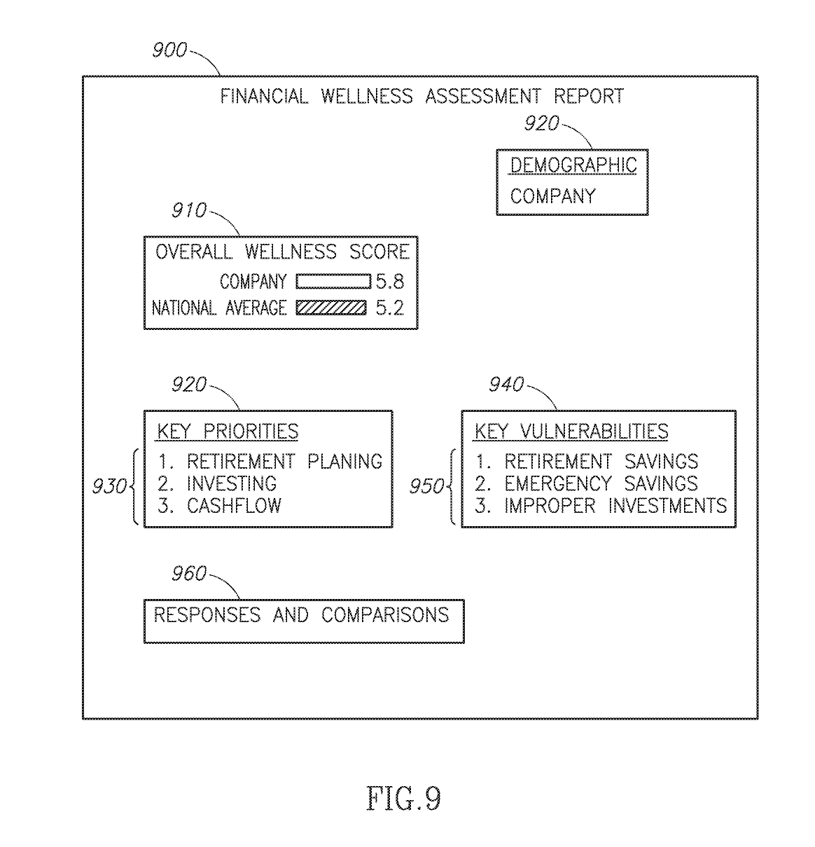

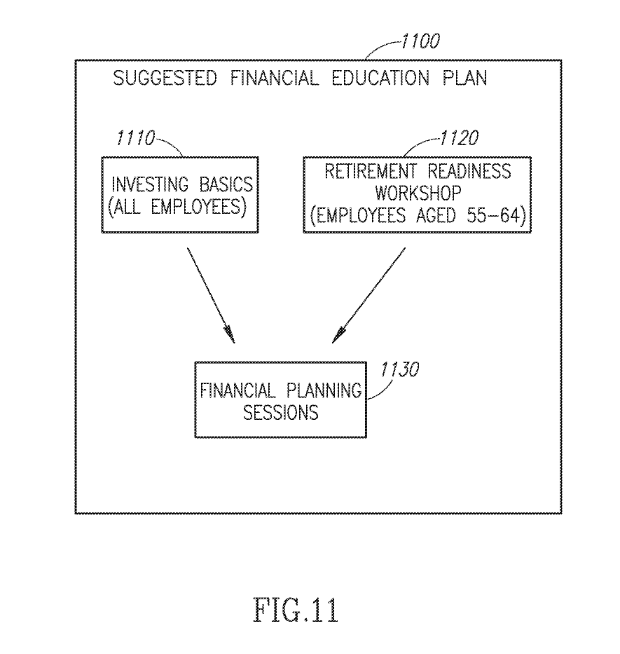

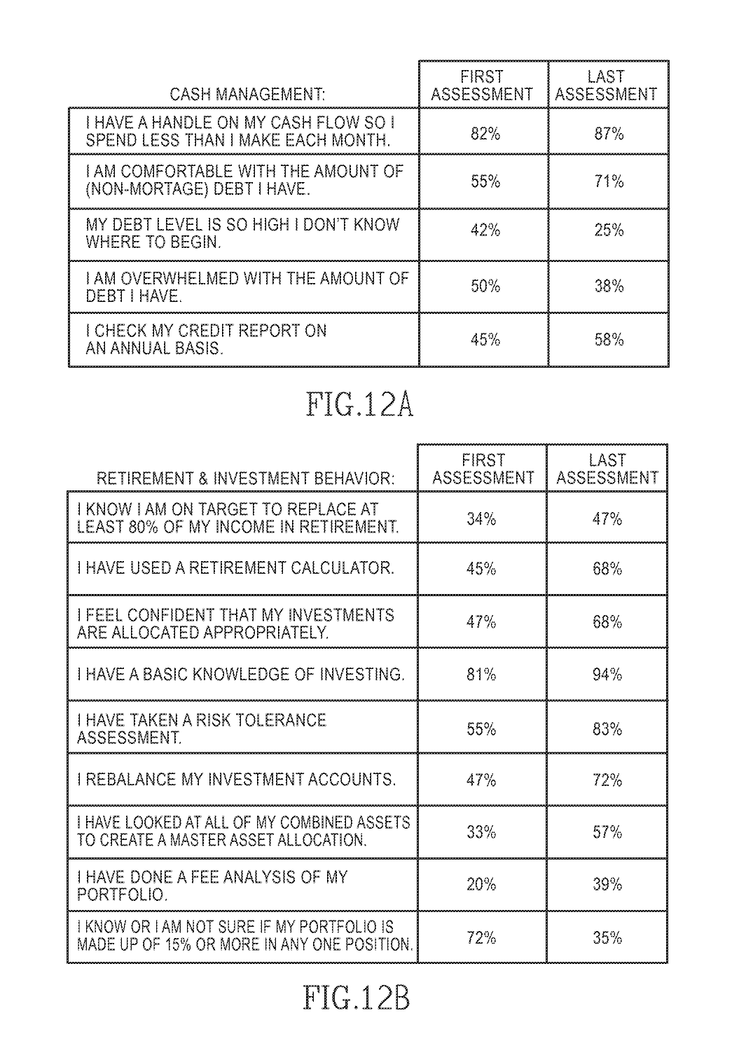

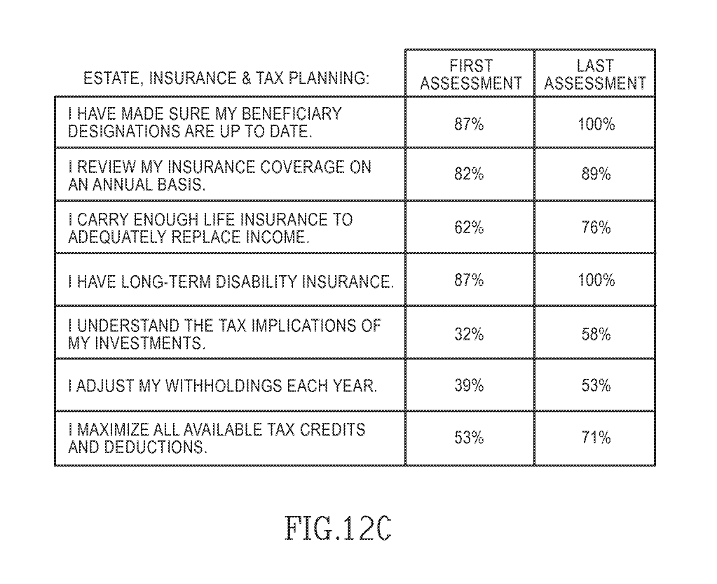

In blocks 808 and 810, the system provides the results of the analysis and the comparison at both the association level and broken down by one or more demographics. In some embodiments, the results may include a summary of the data, one or more scores relating to financial wellness, comparisons (including comparisons of scores or responses between one assessment and another (See FIG. 12), for an individual or for the entire organization or association or a subpopulation thereof), vulnerabilities, priorities, and the like. Non-limiting examples of results data are provided in FIGS. 9, 10 and 12 and discussed below. In addition to providing the results of the analysis and comparisons, the system may provide a recommended financial education plan (which may include one or more financial education events on a topic of interest) to the association or organization based on the analysis of the gathered data (See FIG. 11).

FIG. 9 illustrates a simplified results window 900 (e.g., displayed on a suitable GUI) for providing a financial wellness assessment report to an organization. The window 900 may include a demographic section 920 to indicate the scope of the data provided in the window. In the example shown in FIG. 9, the demographic is the entire organization or “company,” but other similar windows may provide data for one or more subsets of the organization. The results window 900 also includes an overall financial wellness score section 910 that provides a wellness score for the company and the national average wellness score. The results window 900 also includes a key priorities section 920 that includes a list of priorities 930 identified by employees in their individual responses. The results window 900 further includes a key vulnerabilities section 940 that includes a list of vulnerabilities 950 identified by the system's one or more algorithms that were applied during the analysis described above (see block 804 of FIG. 8). In some embodiments, the results window 900 may also include a responses and comparisons section 960 that includes data regarding the employees' responses to questions and comparisons to responses across a larger population. As an example, the responses and comparisons section 960 may indicate that 8% of the company's employees responded that they feel confident that their investments are allocated appropriately, whereas 16% of all respondents nation-wide feel the same. Thus, a company is able to assess particular areas in which their employees may need or want further financially-related education.

As discussed above, the example provided in FIG. 9 illustrates a results window 900 for the entire company (i.e., the demographic section 920 indicates “company”). A plurality of windows similar to the results window 900 may be provided for other demographics. For example, the data may be presented broken down by age group, gender, income, geographic location, and the like.

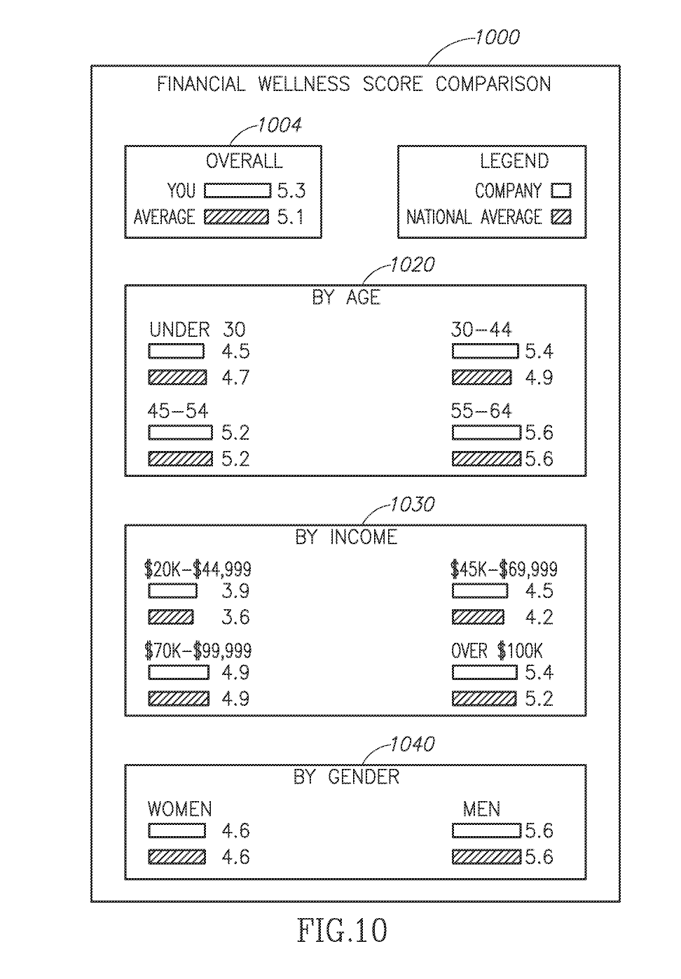

FIG. 10 illustrates an example financial wellness score comparison window 1000 that may be provided so that associations may quickly get a “snapshot” of the overall financial wellness of its associates. The window 1000 may provide an overall score section 1004 that lists the average wellness score for an entire association. The overall score section 1004 may also include an average score so that the association may compare its financial wellness to similarly situated associations. The window 1000 may also include sections 1020, 1030, and 1040 that break down the financial wellness scores of the association by age (section 1020), by income (section 1030), by gender (section 1040), or by other criteria. Using this information, an association may be able to quickly assess the overall financial wellness of its members as well as particular subsets of its members.

FIG. 11 illustrates an example recommended or suggested financial education plan 1100 that may be included with the financial wellness assessment report. In this example, the plan 1100 recommends that all employees receive training and/or support regarding investing basics 1110. The plan 1100 also recommends that the association provide workshops or seminars that cover retirement readiness for employees aged 55-64. The plan 1100 may also include individual financial planning sessions 1130 with a certified financial planner for all employees to help them create and maintain an overall financial plan.

In addition to specific recommended actions, the assessment report may also provide an analysis of the results to address an association's key vulnerabilities and to highlight its strengths.

Although the personalized financial education plan and assessment reports discussed above is concentric to finance, investing, financial planning, finance management or related matters, the methods and systems disclosed, as well as the platforms and algorithms devised, may be adopted for use in any and all topics of interest. For example the inventive methods and systems may be applied for providing personalized educational materials relating to real estate, politics, stocks, college, insurance, executive coaching, or virtually any topic of interest.

Various embodiments of the invention are described above in the Description of the Invention. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at the time of filing this application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention disclosed herein not be limited to the particular embodiments disclosed.
While particular embodiments of the invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.)

What is claimed is:

1. A method for recommending a personalized financial education curriculum to an individual, comprising: utilizing a computer to perform steps comprising:
(1) providing a questionnaire to the individual, wherein the questionnaire comprises one or more questions relating to the individual's comfort level and/or competence and/or preparedness with regard to one or more financial planning topics;
(2) assigning a score to the individual's response to one or more of the questions and/or assigning a score to one or more topics to which one or more of the questions relate, wherein a score for a response to a question is assigned based upon the strength of the response to the question, relative to an ideal response; and a score for a topic is assigned based upon the strength of a response or responses to one or more questions relating to the topic, relative to an ideal response or responses;
(3) generating an electronic financial wellness report for the individual, wherein the electronic financial wellness report comprises scores for two or more of the responses and/or topics; and
(4) generating a list of one or more financial education resources for the individual, wherein said one or more financial education resources are intended to improve a person's comfort level and/or competence with regard to one or more of the topics for which a score lower than a predetermined threshold value was assigned, and wherein at least one listed financial education resource is a financial education event; thereby recommending a personalized financial education curriculum to the individual.

2. The method of claim 1, wherein one or more of the financial education events are accessible via the internet.

3. The method of claim 1, wherein the individual is an employee of an organization, and wherein one or more of the financial education events are held at the employee's place of employment.

4. The method of claim 1, wherein the individual is an employee of an organization, and wherein one or more of the financial education events are not held at the employee's place of employment.

5. The method of claim 1, further comprising providing the individual with access to register for one or more of the financial education events.

6. The method of claim 5, wherein providing the individual with access to register for one or more of the financial education events comprises providing a hyperlink to a webpage where registration for the event can be accomplished.

7. The method of claim 1, further comprising providing the individual with an option to be included in an interest list for one or more of the financial education events.

8. The method of claim 1, further comprising repeating steps 1 and 2 and subsequently generating an updated financial wellness report for the individual, wherein the updated financial wellness report comprises scores of the individual's responses to each of the questionnaires.

9. The method of claim 8, further comprising generating an updated list of one or more financial education resources for the individual, wherein the contents of the updated list are determined in part by the improvement or lack of improvement of a score assigned to a topic on the updated financial wellness report, compared to a previously generated financial wellness report.

10. The method of claim 1, further comprising providing the individual's employer with an electronic copy of the individual's financial wellness report and/or a list of one or more financial education resources recommended for the individual, based upon the list generated in step 4.

11. A non-transitory computer-readable medium having instructions stored thereon that when executed by a processor of a computer cause the computer to perform steps comprising:
(1) providing a questionnaire to the individual, wherein the questionnaire comprises one or more questions relating to the individual's comfort level and/or competence and/or preparedness with regard to one or more financial planning topics;
(2) assigning a score to the individual's response to one or more of the questions and/or assigning a score to one or more topics to which one or more of the questions relate, wherein a score for a response to a question is assigned based upon the strength of the response to the question, relative to an ideal response; and a score for a topic is assigned based upon the strength of a response or responses to one or more questions relating to the topic, relative to an ideal response or responses;
(3) generating an electronic financial wellness report for the individual, wherein the electronic financial wellness report comprises scores for two or more of the responses and/or topics; and
(4) generating a list of one or more financial education resources for the individual, wherein said one or more financial education resources are intended to improve a person's comfort level and/or competence with regard to one or more of the topics for which a score lower than a predetermined threshold value was assigned, and wherein at least one listed financial education resource is a financial education event; thereby recommending a personalized financial education curriculum to the individual.

12. The non-transitory computer-readable medium of claim 11, wherein one or more of the financial education events are accessible via the internet.

13. The non-transitory computer-readable medium of claim 11, wherein the individual is an employee of an organization, and wherein one or more of the financial education events are held at the employee's place of employment.

14. The non-transitory computer-readable medium of claim 11, wherein the individual is an employee of an organization, and wherein one or more of the financial education events are not held at the employee's place of employment.

15. The non-transitory computer-readable medium of claim 11, wherein the steps further comprise providing the individual with access to register for one or more of the financial education events.

16. The non-transitory computer-readable medium of claim 15, wherein providing the individual with access to register for one or more of the financial education events comprises providing a hyperlink to a webpage where registration for the event can be accomplished.

17. The non-transitory computer-readable medium of claim 11, wherein the steps further comprise providing the individual with an option to be included in an interest list for one or more of the financial education events.

18. A method, comprising:
(1) providing an initial multiple choice questionnaire to two or more employees of an organization, wherein the initial multiple choice questionnaire comprises two or more questions and two or more possible answers for each question, and wherein each question is designed to assess an individual's competence and/or comfort level with regard to an aspect of financial planning;
(2) optionally assigning a score to each employee's selected answer to each of the two or more questions included in the initial multiple choice questionnaire, wherein the score is assigned based upon the strength of the selected answer to the question, relative to an ideal answer;
(3) providing a subsequent multiple choice questionnaire to the two or more employees of the organization, wherein the subsequent multiple choice questionnaire comprises two or more questions and two or more possible answers for each question, and wherein (1) each question is designed to assess an individual's competence and/or comfort level with regard to an aspect of financial planning, and (2) each of at least two questions of the subsequent multiple choice questionnaire are the same or substantially the same as a question of the initial multiple choice questionnaire;
(4) optionally assigning a score to each employee's selected answer to each of the two or more questions included in the subsequent multiple choice questionnaire, wherein a score is assigned based upon the strength of the selected answer to the question, relative to an ideal response; and
(5) generating a report comprising a comparison of the employees' selected answers in response to the initial questionnaire and the subsequent questionnaire.

19. The method of claim 18, wherein the comparison of the employees' selected answers comprises a comparison or listing of the number or percentage of employees who selected each of the possible answers in the initial and subsequent questionnaires.

20. The method of claim 18, wherein each step of the method is executed by a computer.

21. The method of claim 20, further comprising providing the report to the employer of the employees.

22. A non-transitory computer-readable medium having instructions stored thereon that when executed by a processor of a computer cause the computer to perform steps comprising:
(1) providing an initial multiple choice questionnaire to two or more employees of an organization, wherein the initial multiple choice questionnaire comprises two or more questions and two or more possible answers for each question, and wherein each question is designed to assess an individual's competence and/or comfort level with regard to an aspect of financial planning;
(2) optionally assigning a score to each employee's selected answer to each of the two or more questions included in the initial multiple choice questionnaire, wherein the score is assigned based upon the strength of the selected answer to the question, relative to an ideal answer;
(3) providing a subsequent multiple choice questionnaire to the two or more employees of the organization, wherein the subsequent multiple choice questionnaire comprises two or more questions and two or more possible answers for each question, and wherein (1) each question is designed to assess an individual's competence and/or comfort level with regard to an aspect of financial planning, and (2) each of at least two questions of the subsequent multiple choice questionnaire are the same or substantially the same as a question of the initial multiple choice questionnaire;
(4) optionally assigning a score to each employee's selected answer to each of the two or more questions included in the subsequent multiple choice questionnaire, wherein a score is assigned based upon the strength of the selected answer to the question, relative to an ideal response; and
(5) generating a report comprising a comparison of the employees' selected answers in response to the initial questionnaire and the subsequent questionnaire.

23. The non-transitory computer-readable medium of claim 22, wherein the steps further comprise providing the generated report to the employer of the employees.
